(19) United States
(12) Patent Application Publication
(10) Pub. No.: US 2024/0320989 A1
(43) Pub. Date: Sep. 26, 2024

(54) METHOD AND SYSTEM FOR PARKING SLOT DETECTION

(71) Applicant: Harman International Industries, Incorporated, Stamford, CT (US)

(72) Inventors: Rengao ZHOU, Shanghai (CN); Min XU, Shanghai (CN)

(21) Appl. No.: 18/575,769

(22) PCT Filed: Jul. 1, 2021
(86) PCT No.: PCT/CN2021/104032

§ 371 Date: Dec. 29, 2023

(51) Int. Cl. G06V 20/58; G06T 3/14

(52) U.S. Cl. CPC G06V 20/586; G06T 3/14

(57) ABSTRACT

A method and system for parking slot detection is disclosed. The method comprises: generating a plurality of DVS frames, each of which is generated by integrating DVS pixels received from a DVS mounted on a vehicle; transforming at least some of the DVS frames to bird-eye view images, so as to form a plurality of bird-eye view images; aligning the plurality of bird-eye view images according to relative positions and/or orientations of the vehicle at the capturing time of the bird-eye view images, so as to form a plurality of aligned bird-eye view images; combing the plurality of aligned bird-eye view images into one output image. The system comprises a DVS mounted on a vehicle configured to capture DVS pixels; and a processor configured to receive the DVS pixels from the DVS and performed the method.

### TECHNICAL FIELD

This disclosure relates in general to a method and a system for a parking slot detection, and particularly to method and a system for a parking slot detection under a dim light condition by using a DVS (Dynamic Vision Sensor).

### BACKGROUND ART

Currently, an APA (Auto Parking Assist) system of a vehicle usually uses a combination of conventional camera and an ultrasonic radar to detect a parking slot. When in the day time or when the light is sufficient, the conventional camera and the ultrasonic radar can work properly to get a satisfactory or acceptable parking slot detection result. However, the conventional camera may provide poor images which may be unclear and/or contain too much noise under a dim light condition. Although the ultrasonic radar is not effected by light conditions, its ranging alone is not accurate enough for a reliable parking slot detection. Thus, the combination of a conventional camera and an ultrasonic radar may not function properly under a dim light condition.

There is a new cutting-edge sensor called DVS. The DVS only captures light intensity changes and then creates asynchronous DVS pixels (pixel events). As compared to a conventional camera, the DVS has advantages of low-latency, no motion blur, high dynamic range and low power consumption. Although the DVS can produce DVS pixels with relatively low noise due to its high dynamic range, it may not directly produce enough DVS pixels that is sufficient for generating an acceptable frame for a parking slot detection under a dim light condition.

Thus, there is a need for a reliable parking slot detection under dim light conditions.

### SUMMARY OF THE INVENTION

According to one of aspects of the disclosure, a method for parking slot detection, is provided, the method comprising: generating a plurality of DVS frames, each of which is generated by integrating DVS pixels received from a DVS mounted on a vehicle; transforming at least some of the DVS frames to bird-eye view images, so as to form a plurality of bird-eye view images; aligning the plurality of bird-eye view images according to relative positions and/or orientations of the vehicle at the capturing time of the bird-eye view images, so as to form a plurality of aligned bird-eye view images; combing the plurality of aligned bird-eye view images into one output image.

According to another aspect of the disclosure, a parking slot detection system is provided, comprising: a DVS mounted on a vehicle configured to capture DVS pixels; a processor configured to perform the above method.

According to another aspect of the disclosure, a vehicle comprising the above parking slot detection system is provided.

According to another aspect of the disclosure, a computer readable storage medium storing a computer program is provided, the computer program can be executed by a processor to perform the above method.

Others systems, method, features and advantages of the disclosure will be, or will become, apparent to one with skill in the art upon examination of the following figures and detailed description. It is intended that all such additional systems, methods, features and advantages be included within this description, be within the scope of the disclosure, and be protected by the following claims.

### BRIEF DESCRIPTION OF THE DRAWINGS

The disclosure can be better understood with reference to the flowing drawings and description. The components in the drawings are not necessarily to scale, emphasis instead being placed upon illustrating the principles of the disclosure. Moreover, in the figures, like reference numerals designate corresponding parts throughout the different views.

FIG. 1 is a schematic diagram showing a vehicle having a parking slot detection system according to one or more embodiments of the present disclosure, the vehicle being passing by parking slots, searching for an available parking slot;

FIG. 2 shows an exemplary DVS frame captured or taken by the DVS of FIG. 1;

FIG. 3 shows a schematic diagram of transforming a DVS frame into a bird-eye view image;

FIG. 4 shows a schematic diagram, the left of which shows pictures of vehicle at four exemplary time t1, t2, t3, t4 when passing by the parking slots, while the right shows four bird-eye view images which are transformed from DVS frames taken by the vehicle 110 at time t1, t2, t3, t4;

FIG. 5 is a schematic diagram showing how two bird-eye view images may be combined into one output image;

FIG. 6 is a schematic diagram showing how bird-eye view images may be combined into one output image;

FIG. 7 shows a flowchart of a method according to one or more embodiments of the present disclosure;

FIG. 8 shows an exemplary process of combing aligned bird-eye view images according to one or more embodiments of the present disclosure;

FIG. 9 shows an exemplary process of combining one bird-eye view image into an output image according to one or more embodiments of the present disclosure.

### BRIEF DESCRIPTION OF THE PREFERRED EMBODIMENTS

Hereinafter, the preferred embodiments of the present disclosure will be described in more detail with reference to the accompanying drawings.

As used herein, the singular forms “a”, “an” and “the” are intended to include the plural forms as well, unless the context clearly indicates otherwise. The terms “comprises”, “comprising”, “includes”, and/or “including”, as used herein, specify the presence of stated features, integers, steps, operations, elements, and/or components, but do not preclude the presence or addition of one or more other features, integers, steps, operations, elements, components, and/or groups thereof. As used herein, the term “and/or” and the symbol “/” are meant to include any and all combinations of one or more of the associated listed items.

Additionally, while the terms “first”, “second”, etc. may be used herein to describe various elements, components, steps or calculations, these elements, components, steps or calculations should not be limited by these terms, rather these terms are only used to distinguish one element, component, step or calculation from another. For example, a first component could be termed a second component, similarly a first calculation could be termed a second calculation; similarly a first step could be termed a second step; all without departing from the scope of the present disclosure.

As used herein, the terms “DVS pixel”, “pixel event”, “event” may be used interchangeable, and may refer to a light intensity change captured by a DVS. A DVS pixel or pixel event or event may be represented by a pixel or event data, which normally takes a form of [x, y, t, p], in which x and y stand for the x coordinates and y coordinates, t stands for the time stamp of this event, and p stands for the polarity of the event, meaning whether the light intensity change is becoming brighter or darker. The terms “frame” of a DVS, or “DVS frame” refer to an image or frame into which all the pixels taken by a DVS within a timespan are integrated. The term “capturing time” of a DVS frame or a bird-eye view image means the time when the DVS pixels are captured or taken, such as a mid-time of the time span of the DVS frame, despite of the time when the DVS pixels are actually integrated into the DVS frame. The term “dim light condition” means a condition where the light or environment light is insufficient for a combination of conventional camera and an ultrasonic radar to properly detect a parking slot, such as an open ground parking slot and without street lights at night, either with or without moonlight.

To clarify the use in the pending claims and to hereby provide notice to the public, the phrases “at least one of <A>, <B>, . . . and <N>” or “at least one of <A>, <B>, . . . <N>, or combinations thereof” are defined by the Applicant in the broadest sense, superseding any other implied definitions herebefore or hereinafter unless expressly asserted by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

A DVS only captures light intensity changes and then creates asynchronous DVS pixels (pixel events). Unlike the conventional camera which creates a complete image or frame comprising continuous pixels, a DVS only creates asynchronous DVS pixels which may be discrete and discontinuous in space and time, and thus it is needed to integrate DVS pixels (pixel events) captured by a DVS within a timespan in order to produce an image or frame. As compared to a conventional camera, the DVS has advantages of low-latency, no motion blur, high dynamic range and low power consumption.

Due to its high dynamic range, the DVS would produce DVS pixels with relatively low noise, and thus a more reliable DVS frame or image may be produced by incorporating DVS pixels within a time span even under dim light conditions. However, it is not applicable to directly use a DVS to replace a conventional camera, because the DVS may not capture enough light intensity changes so as to create sufficient DVS pixels for a recognizable or detectable frame or image under dim light condition.

The present disclosure provides a method and a system for parking slot detection under dim light conditions by using a DVS mounted on a vehicle. In the method and system, a plurality of DVS frames are transformed to bird-eye view images. Then the bird-eye view images are translated and/or rotated to as to be aligned with one another according the relative positions and/or orientations of the vehicle at the capturing time of the bird-eye view images. Then the aligned bird-eye view images are combined into one output image.

Normally, the vehicle is moving while the DVS frames are being taken, and the plurality of DVS frames taken by the DVS at least partially overlap with one another and each of the DVS frames may only contain image of a small area or portion of an entire parking slot.

The applicants have found that each of the DVS frames may not contain enough DVS pixels and thus may not be clear enough for a parking slot detection or recognition due to the dim light condition. In addition, the applicants have also found that each of the DVS frames contains a relatively low level of noise despite of the low dim light condition due to the high dynamic range of the DVS. Thus, although each of the DVS frames may not contain enough DVS pixels, the output image of the present disclosure may contain sufficient DVS pixels and thus may be clear enough for a parking slot detection or recognition since the DVS pixels in multiple DVS frames (aligned bird-eye view images) have been combined into the output image. In addition, although the noise level of the combined output image may be multiplied due to the combing operation of multiple DVS frames (aligned bird-eye view images), the noise level of the combined output image may be still within an acceptable range due to the low noise level of each DVS frame.

In addition, by using the method of the present disclosure, the output image may contain image of an entire parking slot for a parking slot detection.

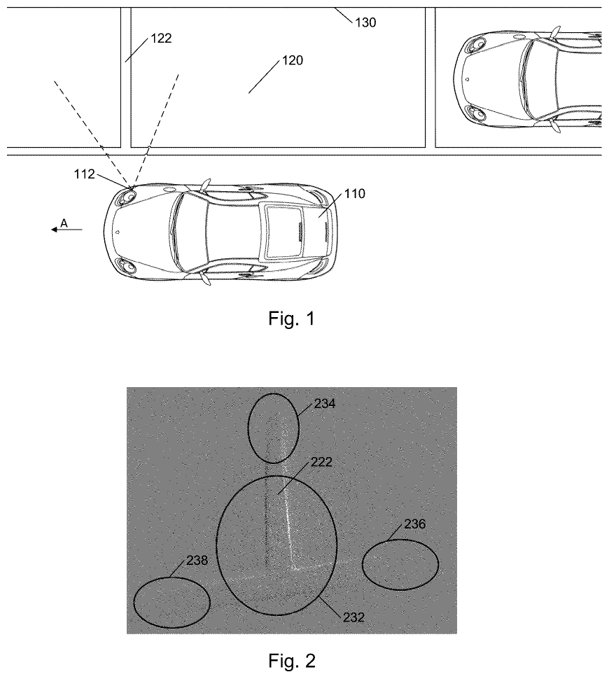

FIG. 1 is a schematic diagram showing a vehicle 110 having a parking slot detection system according to one or more embodiments of the present disclosure. The parking slot detection system comprises a DVS 112 mounted on the vehicle. As shown, there are a plurality of consecutive parking slots 120 located along a road edge 130, and the vehicle 110 is moving in a direction shown in an arrow A alongside the parking slots 120, searching for an available parking slot. Each of the parking slots is defined by parking slot lines 122.

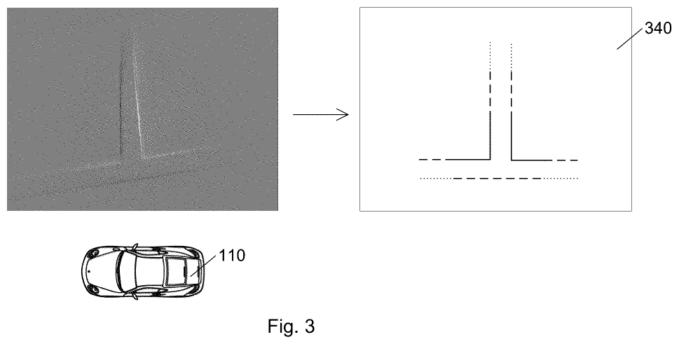

FIG. 2 shows an exemplary DVS frame captured or taken by the DVS 112 of FIG. 1 under a dim light condition. As used herein, the term “DVS frame captured by a DVS” or “DVS frame taken by a DVS” means a DVS frame produced by integrating DVS pixels captured by a DVS within a time span. The inventor of the present disclosure has found that under dim light conditions, the DVS would usually not be able to produce a full depiction of the parking slot lines. For example, as shown in FIG. 2, in the DVS frame, a portion of the parking slot lines 222 encircled by a circle 232 may be clearer than other portions, such as those encircled by circles 234, 236, 238, which may be relatively vague. Normally, the parking slot lines 222 closer to the DVS may be relatively clear while the parking slot lines farther to the DVS may be relatively vague. This is because the diffused reflection from the parking slot lines is well diffused, and the reflection of parking slot lines closer to the DVS is easier to be captured by the DVS. That is, due to the dim light condition, the DVS may not capture enough light intensity changes for a DVS frame that is sufficient for a parking slot detection.

In order to use the DVS frames for a parking slot detection, multiple DVS frames are first transformed to bird-eye view images, which are then translated, rotated and combined to a combined output image.

FIG. 3 shows a schematic diagram of transforming a DVS frame into a bird-eye view image. The left picture is a DVS frame captured by the vehicle 110 while the right picture 340 is a bird-eye view image transformed from the DVS frame. For sake of clarity, the parking slot lines in the right picture 340 are represented by lines, with the solid line representing the parking slot lines that are relatively clear, the dotted line representing the parking slot lines that are relatively vague and the dashed line representing the parking slot lines that are not as clear as those shown in solid lines but are clearer than those shown in dotted lines. As shown, only a portion of an entire parking slot is shown in a DVS frame or a bird-eye view image. The transforming process is performed by a known algorithm in the art, such as a homography transformation, which uses the intrinsics, such as a focal length and optical center of DVS, and the extrinsics, such as rotation and translation from the sensor coordinate to the world coordinate, of the DVS to produce bird-eye view images from DVS frames. The detailed description of the algorithm is omitted for sake of clarity. In one or more embodiments of the present disclosure, a noise filter, such as median filter, may be applied to the DVS frames before the transformation in order to reduce white noise.

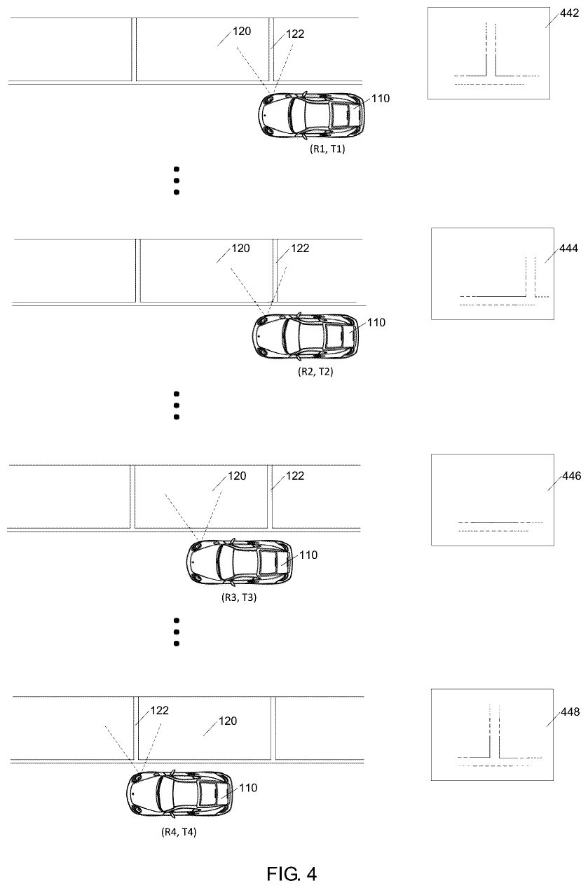

FIG. 4 shows a schematic diagram, the left of which shows pictures of vehicle 110 at four exemplary time t1, t2, t3, t4 when passing by the parking slots 120, while the right shows four bird-eye view images, i.e., image 442, image 444, image 446 and image 448, which are transformed from DVS frames taken by the vehicle 110 at time t1, t2, t3, t4. As shown, the vehicle 110 is in (R1, T1) at time t1, in (R2, T2) at time t2, in (R3, T3) at time t3 and in (R4, T4) at time t4, wherein R1, R2, R3 and R4 stand for respective rotational positions of the vehicle 110 at time t1, t2, t3, t4 while T1, T2, T3, T4 stand for respective translational positions of the vehicle 110 at time t1, t2, t3, t4. In the example shown in FIG. 4, the vehicle 110 moves linearly without any rotation, and thus R1=R2=R3=R4. However, the present disclosure is not limited thereto and the vehicle may move in any suitable combination of translational movement and rotational movement. Although FIG. 4 only shows four pictures of the vehicle 110 at four exemplary time t1, t2, t3, t4 as well as four corresponding bird-eye view images, it may be appreciated that these pictures are merely exemplary and in a parking slot detection process, the vehicle 110 may take any suitable number of DVS frames and correspondingly number of bird-eye view images may be produced by transforming the DVS frames.

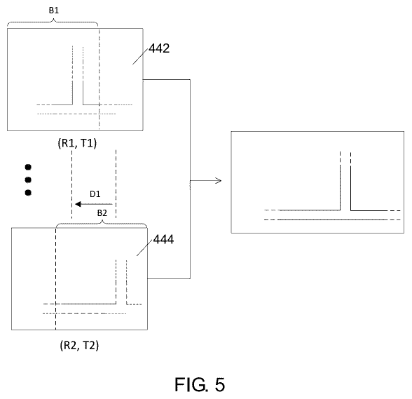

FIG. 5 is a schematic diagram showing how two bird-eye view images 442, 444 may be combined into one output image. As shown in FIG. 4, the DVS frame corresponding to the bird-eye view image 442 is taken at time t1 when the vehicle 110 is in (R1, T1), and the DVS frame corresponding to the bird-eye view image 444 is taken at time t2 when the vehicle 110 is in (R2, T2). Since (R1, T1) is not equal to (R2, T2), the parking slot lines in the bird-eye view image 444 need to be translated and/or rotated so that they may be aligned with their corresponding parking slot lines in the bird-eye image 442. As shown in FIG. 5, the parking slot lines in the bird-eye view image 444 need to be translated in the direction shown in an arrow D1 so that they may be aligned with their corresponding parking slot lines in the bird-eye image 442. Then the two aligned images may be combined by combining each of the DVS pixels in the bird-eye view image 444 into the bird-eye view image 442. Or alternatively, the two aligned images may be combined by combining all the DVS pixels in the bird-eye view image 444 and all the DVS pixels in the bird-eye view image 442 to an output image. As shown, since the bird-eye view image 442 has been aligned with the bird-eye view image 444 before they are combined together, the relatively clear area in the bird-eye view image 442 and the bird-eye view image 444 may be combined so that the relatively clear area in the combined output image (shown in solid lines) is enlarged as compared to the relatively clear areas in the bird-eye view image 442 and the bird-eye view image 444. As will be appreciated, the area B1 in image 442 will be aligned and overlapped with the area B2 in image 444 after the image 444 is translated as shown by arrow D1. The inventor of the present disclosure has found that although in human's eyes, the DVS pixels in the DVS frame seems to be continuous, the DVS pixels are actually discontinuous, even in the relatively clear area of a DVS frame, such as that shown in FIG. 2. Thus, the DVS pixels in the bird-eye view images are also discontinuous. In addition, the inventor of the present disclosure has also found that, for aligned bird-eye view images, such as aligned image 442 and image 444, any of the discontinuous DVS pixels in the aligned image 442 may have a good chance to have a different coordinate position than any of the DVS pixels in the aligned image 444. Thus, by combining aligned bird-eye view images together, the combined output image may be clearer throughout the image, no matter in the area corresponding to the relatively clear area of the image 442 and image 444 or the area corresponding to the relatively vague area of the image 442 and image 444. In addition, it is possible to obtain a relative clear result in the combined output image from relatively vague areas of the aligned bird-eye view images, as long as sufficient number of aligned bird-eye view images are combined together.

In one or more embodiments of the present disclosure, a DVS frame or a bird-eye view image may be visualized as a greyscale, and each of the pixels in a DVS frame or a bird-eye view image may have multiple possible grey levels. Normally, each of the pixels of a greyscale may have 256 possible grey levels, i.e., from grey level 0 to grey level 255, wherein grey level 0 is white while grey level 255 is black and grey levels 1-254 are grey levels between white and black. However, the present disclosure is not limited thereto and the DVS frame or the bird-eye view image of the present disclosure may be a greyscale having any suitable grey levels. In one or more embodiments of the present disclosure, the background color is an intermediate grey level between grey level 0 and grey level 255. In one or more embodiments of the present disclosure, the background color may be grey level 128. In one or more embodiments of the present disclosure, when p in [x, y, t, p] of a DVS pixel indicates that the light intensity is becoming darker, the grey level of the corresponding DVS pixel in the DVS frame may be set to be grey level 255, and when p in [x, y, t, p] of a DVS pixel indicates that the light intensity is becoming brighter, the grey level of the corresponding DVS pixel in the DVS frame may be set to be grey level 0. In such embodiments, any pixel in a DVS frame or a bird-eye view image may be in one of three possible grey levels, i.e., grey level 0, grey level 128 and grey level 255. In some other embodiments of the present disclosure, the three possible grey levels may be grey levels other than grey level 0, grey level 128 and grey level 255, as long as the three possible grey levels are easily distinguishable from one another.

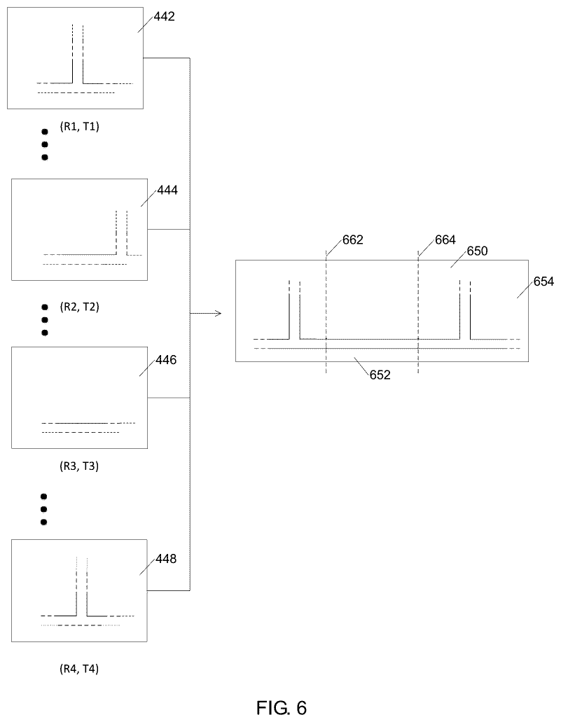

FIG. 6 is a schematic diagram showing how bird-eye view images may be combined into one output image. Although there are only four bird-eye view images 442, 444, 446, 448 shown in FIG. 6, it may be appreciated that there may be any suitable number of bird-eye view images. The process of combining the bird-eye view images into one output image may be similar to that shown in FIG. 5. Particularly, each of the bird-eye view image other than the bird-eye view image 442 is translated and/or rotated so that it is aligned with the bird-eye view image 442, and then each of the translated and/or rotated bird-eye view image is combined into the bird-eye view image 442. As shown in the combined output image 650, almost the entire parking slot is shown in solid lines, which means that almost the entire parking slot is relatively clear. That is, the combined output image 650 contains a relatively clear image of an entire parking slot, and thus can be used for a parking slot detection.

In the present disclosure, the plurality of DVS frames taken by the DVS at least partially overlap with one another. In one or more embodiments of the present disclosure, a majority of any two consecutive DVS frames or the bird-eye view images may overlap with one another, e.g., at least 95%, at least 90%, at least 85%, at least 80%, at least 75% or at least 70% of the area of two consecutive DVS frames or the bird-eye view images may overlap with one another.

As discussed above, the DVS pixels in the DVS frames or the bird-eye view images may be actually discontinuous, even in relatively clear areas. Thus, in the combined output image, DVS pixels from overlapping areas of different DVS frames or the bird-eye view images may complement one another, resulting in a denser DVS pixels in the overlapping areas, and thus a clearer or more recognizable output image. This works for both relatively clear areas and relatively vague areas of the aligned bird-eye view images. The inventor has found that even for the relatively clear areas of the DVS frames or the aligned bird-eye view images, DVS pixel density is not high due to the dim light condition. Thus, when two relatively clear areas to be combing together, there is still a good chance for DVS pixels from one relatively clear area to complement DVS pixels from the other. As for two relatively vague areas combining together, there is an even better chance for DVS pixels from one relatively vague area to complement DVS pixels from the other. Thus, the combined output image will be clearer for both of the relatively clear areas and the relatively vague areas. And more importantly, as for the relatively vague areas, the combined output image may be sufficiently clear as long as enough number of overlapped relatively vague areas are combined together. On the other hand, as discussed above, a DVS has the technical advantage of a high dynamic range, which results in a low noise level of the DVS frames or bird-eye view images even under dim light condition. Thus, even multiple bird-eye view images are combined together, the combined output image still has a relatively low noise level.

In one or more embodiments of the present disclosure, the DVS 110 operates at a frequency of about 100 Hz. That is, the DVS frames of the DVS 110 may be generated at a frequency of about 100 Hz. The present disclosure is not limited thereto and the DVS of the present disclosure may operates at any suitable frequency.

In the embodiments shown in FIG. 6, each of the aligned bird-eye view images 442, 444, 446, 448 is combined into the output image as a whole. However, the present disclosure is not limited thereto. In one or more embodiments of the present disclosure, for some of the aligned bird-eye view images, only a portion of the aligned bird-eye view image, such as a relatively vague area of the image, is combined into the output image. For example, in the example shown in FIG. 6, the upper portion of each of the aligned bird-eye view images may be relatively vague. It may be advantageous to combine only upper portion of some aligned bird-eye view images into the output image, so as to obtain an overall clear output image.

As used herein, the term “time interval” means a time interval or a time period between two consecutive DVS frames that may be transformed to bird-eye view images and combined into an output image. In one or more embodiments of the present disclosure, each of the DVS frames may be transformed to bird-eye view images, and then combined into an output image.

That is, there may be no time interval between two consecutive DVS frames that may be transformed to bird-eye view images and combined into an output image. In some embodiments of the present disclosure, only some of the DVS frames may be transformed to bird-eye view images, and then combined into an output image. In some embodiments of the present disclosure, there exists a time interval between two consecutive DVS frames that may be transformed to bird-eye view images and combined into an output image, and the time interval may be adjusted based on a number or density of DVS pixels in a combined region in the output image. In some embodiments of the present disclosure, the time interval may be increased when the number, density or maximum density of DVS pixels in a combined region exceeds a first threshold value and the time interval may be decreased when the number, density or maximum density of DVS pixels in a combined region is lower than a second threshold value which is less than the first threshold value. In one or more embodiments of the present disclosure, the first threshold value may be about 70% or 80%, and the second threshold value may be about 30% or 40%. With the adjusted time interval, the whole combined output image may be properly combined, and may be sufficiently clear for a parking slot detection while still have a relatively low noise level.

As used herein, the term “combined region” means a region in the output image that has finished the combining operation. For example, when combining the bird-eye view image 446 into the output image 650, the region 652 between the dashed lines 662, 664 (corresponding to the boundaries of the bird-eye view image 446) may be a “combining region”, to which the current image (bird-eye view image 446) is combining. The region 654 right of the dashed line 664 may be a “combined region” while the region left of the dashed line 662 may be a “region to be combined”.

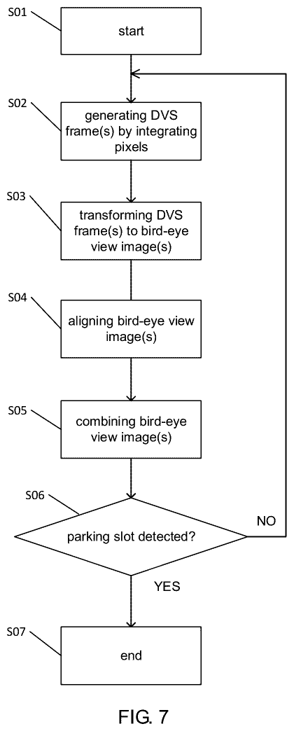

FIG. 7 shows a flowchart of a method according to one or more embodiments of the present disclosure. The process starts at S01 and then goes to S02. At S02, a DVS frame or DVS frames are generated, each of the DVS frame is generated by integrating DVS pixels captured by a DVS within a timespan. Then the process goes to S03, at which the DVS frame(s) is transformed to a bird-eye view image(s). Then the process goes to S04, at which the bird-eye view image(s) are aligned with one another. The aligning step may be omitted if the current bird-eye view image is the first one. Then the process goes to S05, at which the aligned bird-eye view images are combined into one output image. Then the process goes to S06, at which it is decided whether or not an available parking slot is detected from the output image. If an available parking slot is detected, the process ends and may go to a further process such as an APA (Auto Parking Assist) process. If an available parking slot is not detected, the process goes back to step S02, at which a further DVS frame or DVS frames are generated, each of the DVS frame is generated by integrating DVS pixels captured by a DVS within a timespan.

In one or more embodiments of the present disclosure, the method of the present disclosure further comprises a step of adjusting a time interval between consecutive DVS frames that may be transformed to bird-eye view images and/or combined into an output image based on a combined region in the output image, such as the maximum density of the DVS pixels in the combined region of the output image. In some embodiments of the present disclosure, the time interval may be increased when the maximum density of the DVS pixels of DVS pixels in a combined region exceeds a first threshold value and the time interval may be decreased when the maximum density of the DVS pixels in a combined region is lower than a second threshold value which is less than the first threshold value.

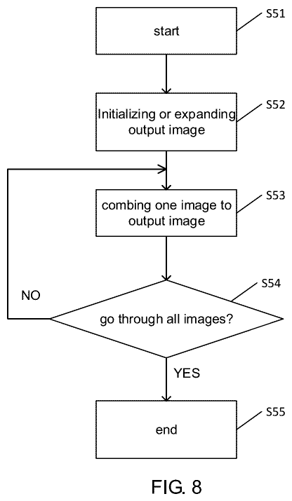

FIG. 8 shows an exemplary process of the step S05 of FIG. 7 according to one or more embodiments of the present disclosure. The process starts at S51 and then goes to S52, at which an output image is initialized by setting all pixels in the output image to a background color (grey level) if the output image does not exist yet. Or alternatively, if the output image already exists, then the output image may be expanded as needed so that it can accommodate a new bird-eye view image to be combined. Then the process goes to S53, at which one bird-eye view image is combined into the output image. Then the process goes to S54, at which it is decided whether or not all bird-eye view images have been combined into the output image. If it is decided that all of the plurality of consecutive frames have been combined into the output image, then the process goes to S55. Otherwise, the process goes back to S53, at which a next one of the bird-eye view images is combined into the output image.

Although FIG. 8 shows an exemplary process of the step S05 of FIG. 7, the present disclosure is not limited thereto. For example, in some other embodiments, one of the bird-eye view images, e.g., the first bird-eye view image, may be set as an output image and each of the other(s) of the bird-eye view images may be combined into the output image. In one or more embodiments of the present disclosure, the step S05 only combine one aligned bird-eye view images into the output image, and thus the step S54 in FIG. 8 may be omitted.

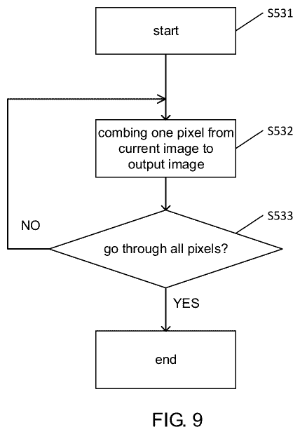

FIG. 9 shows an exemplary process of the step S53 of FIG. 8 according to one or more embodiments of the present disclosure. The process starts at S531 and then goes to S532, at which one DVS pixel from the current bird-eye view image is combined into the output image. Then the process goes to S533, at which it is decided whether or not all of the DVS pixels in the current bird-eye view image have been combined into the output image. If it is decided that all of the DVS pixels in the current bird-eye view image have been combined into the output image, then the process goes to an end. Otherwise, the process goes back to S532, at which a next one of the DVS pixels in the current bird-eye view image is combined into the output image.

Although FIG. 9 shows an exemplary process of the step S53 of FIG. 8, the present disclosure is not limited thereto. In one or more embodiments of the present disclosure, combining one bird-eye view image into the output image comprises combing a portion of at least one aligned bird-eye view images into the output image.

According to some embodiments of the disclosure, the present disclosure can be implemented as follows.

Item 1: a method for parking slot detection, comprising:
generating a plurality of DVS frames, each of which is generated by integrating DVS pixels received from a DVS mounted on a vehicle;
transforming at least some of the DVS frames to bird-eye view images, so as to form a plurality of bird-eye view images;
aligning the plurality of bird-eye view images according to relative positions and/or orientations of the vehicle at the capturing time of the bird-eye view images, so as to form a plurality of aligned bird-eye view images;
combing the plurality of aligned bird-eye view images into one output image.

Item 2: the method of item 1, further comprising detecting whether or not the output image contains an available parking slot.

Item 3: the method of any of Items 1-2, wherein at least some of the DVS frames contains an image of at least a portion of a parking slot.

Item 4: the method of any of Items 1-3, wherein the output image contains an image of an entire parking slot.

Item 5: the method of any of Items 1-4, wherein aligning the bird-eye view images comprises translating and/or rotating the bird-eye view images.

Item 6: the method of any of Items 1-5, wherein combing the aligned bird-eye view images into one output image comprises combining each of the aligned bird-eye view images into the output image one by one.

Item 7: the method of any of Items 1-6, wherein combining an aligned bird-eye view image into the output image comprises combining each of the DVS pixels in the aligned bird-eye view image into the output image.

Item 8: the method of any of Items 1-7, further comprising initializing each pixel in the output image to a background color.

Item 9: the method any of Items 1-8, wherein combining a DVS pixel into the output image comprises copying a grey level of the DVS pixel to a corresponding pixel in the output image.

Item 10: the method of any of Items 1-9, further comprising adjusting a time interval between the aligned bird-eye view images to be combined based on a number or density of DVS pixels in at least a portion of the output image.

Item 11: the method of any of Items 1-10, wherein the time interval is adjusted based on a number or density of DVS pixels in a combined region in the output image.

Item 12: the method of any of Items 1-11, wherein combing the plurality of aligned bird-eye view images into one output image comprises combing a portion of at least one aligned bird-eye view images into the output image.

Item 13: the method of any of Items 1-12, wherein the plurality of bird-eye view images at least partially overlap with one another.

Item 14: a parking slot detection system, comprising:
a DVS mounted on a vehicle configured to capture DVS pixels;
a processor configured to perform a method of any of the Items 1-13.

Item 15: a vehicle comprising a parking slot detection system of Item 14.

Item 16: a computer readable storage medium storing a computer program that can be executed by a processor to perform a method of any of Items 1-13.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.”

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Systems and methods have been described in general terms as an aid to understanding details of the disclosure. In some instances, well-known structures, materials, and/or operations have not been specifically shown or described in detail to avoid obscuring aspects of the disclosure. In other instances, specific details have been given in order to provide a thorough understanding of the disclosure. One skilled in the relevant art will recognize that the disclosure may be embodied in other specific forms, for example to adapt to a particular system or apparatus or situation or material or component, without departing from the spirit or essential characteristics thereof. Therefore the disclosures and descriptions herein are intended to be illustrative, but not limiting, of the scope of the disclosure. Accordingly, the disclosure is not to be restricted except in light of the attached claims and their equivalents.

1. A method for parking slot detection, comprising:
generating a plurality of DVS frames, each of which is generated by integrating DVS pixels received from a DVS mounted on a vehicle;
transforming at least some of the DVS frames to bird-eye view images, so as to form a plurality of bird-eye view images;
aligning the plurality of bird-eye view images according to relative positions and/or orientations of the vehicle at the capturing time of the bird-eye view images, so as to form a plurality of aligned bird-eye view images;
combing the plurality of aligned bird-eye view images into one output image.

2. The method of claim 1, further comprising detecting whether or not the output image contains an available parking slot.

3. The method of claim 1, wherein at least some of the DVS frames contains an image of at least a portion of a parking slot.

4. The method of claim 3, wherein the output image contains an image of an entire parking slot.

5. The method of claim 1, wherein aligning the bird-eye view images comprises translating and/or rotating the bird-eye view images.

6. The method of claim 1, wherein combing the aligned bird-eye view images into one output image comprises combining each of the aligned bird-eye view images into the output image one by one.

7. The method of claim 6, wherein combining an aligned bird-eye view image into the output image comprises combining each of the DVS pixels in the aligned bird-eye view image into the output image.

8. The method of claim 7, further comprising initializing each pixel in the output image to a background color.

9. The method claim 7, wherein combining a DVS pixel into the output image comprises copying a grey level of the DVS pixel to a corresponding pixel in the output image.

10. The method of claim 1, further comprising adjusting a time interval between the aligned bird-eye view images to be combined based on a number or density of DVS pixels in at least a portion of the output image.

11. The method of claim 10, wherein the time interval is adjusted based on a number or density of DVS pixels in a combined region in the output image.

12. The method of claim 1, wherein combing the plurality of aligned bird-eye view images into one output image comprises combing a portion of at least one aligned bird-eye view images into the output image.

13. The method of claim 1, wherein the plurality of bird-eye view images at least partially overlap with one another.

14. A parking slot detection system, comprising:
a DVS mounted on a vehicle configured to capture DVS pixels;
a processor configured to perform the method of claim 1.

15. A vehicle comprising the parking slot detection system of claim 14.

16. A computer readable storage medium storing a computer program that can be executed by a processor to perform the method of claim 1.
